(19) United States
(12) Patent Application Publication
(10) Pub. No.: US 2016/0023471 A1
(43) Pub. Date: Jan. 28, 2016

(54) DIGITAL PRINTING SYSTEM FOR CYLINDRICAL CONTAINERS

(71) Applicant: James M. Jeter, Jacksonville, FL (US)

(72) Inventor: James M. Jeter, Jacksonville, FL (US)

(21) Appl. No.: 14/808,571

(22) Filed: Jul. 24, 2015

Related U.S. Application Data
(60) Provisional application No. 62/028,464, filed on Jul. 24, 2014.

(51) Int. Cl. B41J 2/21

(52) U.S. Cl. CPC B41J 2/2103

(57) ABSTRACT

A digital printing system for cylindrical containers having a plurality of print stations for each section of the cylindrical container being printed. Each of the four stations is dedicated to one of four specific colors, Cyan, Magenta, Yellow and Black (CMYK).

### CROSS-REFERENCE TO RELATED APPLICATION

This application claims priority to application No. 62/028,464, filed on Jul. 24, 2014, which is currently pending. The patent application identified above is incorporated herein by reference in its entirety to provide continuity of disclosure.

### FIELD OF THE INVENTION

This invention relates generally to cylindrical can decorating and printing equipment and more particularly to a digital printing system using process color printing for printing labels on cylindrical containers for the beverage, cosmetic, medical and consumer packaging industries.

### BACKGROUND OF THE INVENTION

Conventional methods for printing labels on cylindrical containers use spot color printing, in which specific colored inks are used to generate the colors appearing on paper. However, spot color printing is expensive and time consuming as it requires specific colors to be individually mixed or prepared prior to or during printing and each printed using an individual printing plate. It also requires that each individual color be applied to a substrate individually.

Therefore, a need exists for a system of printing cylindrical containers in which the colors are produced during the printing process using process color printing and printed using a limited number of printing stations.

### SUMMARY OF THE INVENTION

The primary object of the present invention is to provide a digital printing system that uses four process color printing as opposed to spot color printing to produce high resolution images on cylindrical containers for the beverage, cosmetic, medical and consumer packaging industries.

An additional object of the present invention is to provide a digital printing system that prints various sizes and shapes of cylindrical containers using a plurality of printing heads to print on angled necks and multiple substrates.

The present invention fulfills the above and other objects by providing a digital printing system having a multi station indexing table that is loaded from a servo driven gravity fed star-wheel. The table is driven by a servo motor system to provide rigidity and accuracy to the system while cylindrical containers are moved through one of four print stations for each section of the cylindrical container being printed. Each of the four stations is dedicated to one of four specific colors, Cyan, Magenta, Yellow and Black (CMYK). The size and shape of the cylindrical containers being printed in a production run determines the number of groupings stations being used during the printing process. For example, a 24 oz. can having an angled neck will travel through four stations having angled print heads to print the neck, four print stations to print the upper half of the flat surface of the can and four stations to print the lower half of the flat surface of the can. Station may be activated or deactivated during a production run depending on the size and shape of the can. The use of four process color printing allows any color to be printed on the can using (CMYK) without the need for preparing each individual color ink as is currently required with conventional spot printing.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a top view of a machine module layout showing multiple digital printing system tables of the present invention arranged in a production line;

FIG. 2 is a side perspective view of a digital printing system of the present invention and ink management system;

FIG. 3 is a top view of a digital printing system table of the present invention showing various stations located around the table that a container passes through during the printing process;

FIG. 4 is a side perspective view of an infeed station and a discharge station of the present invention;

FIG. 5 is a side perspective view of a printing station of the present invention;

FIG. 6 is a partial cutaway side view of a neck printing station of the present invention;

FIG. 7 is a detailed view of section A of FIG. 6;

FIG. 8 is a side view of a cylindrical container having an angled neck; and

FIG. 9 is a side perspective view of a clear coating system of the present invention;

FIG. 10 is a side view of a digital printing system table and vacuum system of the present invention;

FIG. 11 is a cutaway side view of a digital printing system table and vacuum system of the present invention along lines A-A of FIG. 10;

FIG. 12 is a cutaway side view of a digital printing system table and vacuum system of the present invention along lines A-A of FIG. 10 showing the vacuum supply;

FIG. 13 is a side perspective view of a digital printing system table and vacuum system of the present invention; and

FIG. 14 is a side view of an inspection system station of the present invention.

### DESCRIPTION OF THE PREFERRED EMBODIMENTS

For purposes of describing the preferred embodiment, the terminology used in reference to the numbered accessories in the drawings is as follows:
1. digital printing system station one
2. digital printing system station two
3. digital printing system station three
4. digital printing system station four
5. digital printing system station five
6. digital printing system station six
7. digital printing system station seven
8. digital printing system station eight
9. digital printing system station nine
10. digital printing system station ten
11. digital printing system station eleven
12. digital printing system station twelve
13. digital printing system station thirteen
14. digital printing system station fourteen
15. digital printing system station fifteen
16. digital printing system station sixteen
17. digital printing system station seventeen
18. digital printing system station eighteen
19. indexing table (digital printing system)
20. infeed station mechanism
21. servo motor
22. mandrel
23. vacuum
24. drive shaft
25. cylindrical container
26. print head
27. vacuum pick and place system
28. suction cup
29. transfer system
30. indexing table (clear coating system)
31. clear coating system station one
32. clear coating system station two
33. clear coating system station three
34. clear coating system station four
35. clear coating system station five
36. clear coating system station six
37. clear coating system station seven
38. clear coating system station eight
39. slide
40. ported plate
41. valve
42. valve body
43. tubing
44. check valve
45. micrometer transmitter
46. receiver
47. amplifier
48. mirror
49. laser beam
50. air purge nozzle

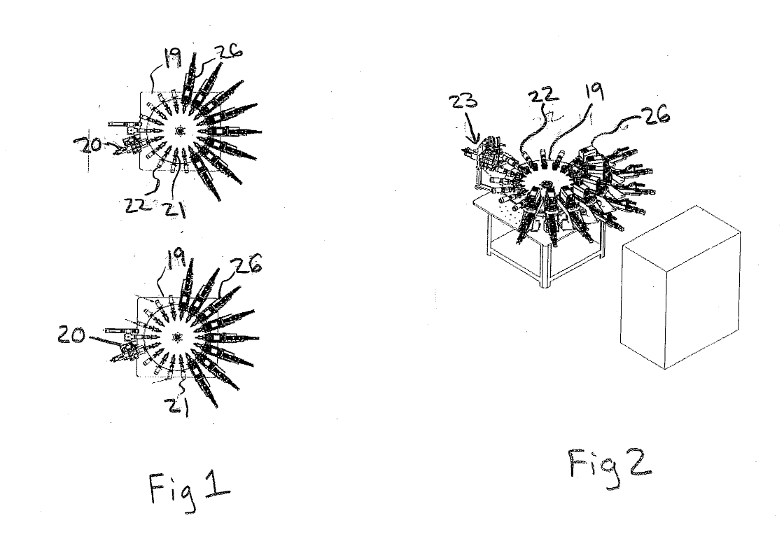

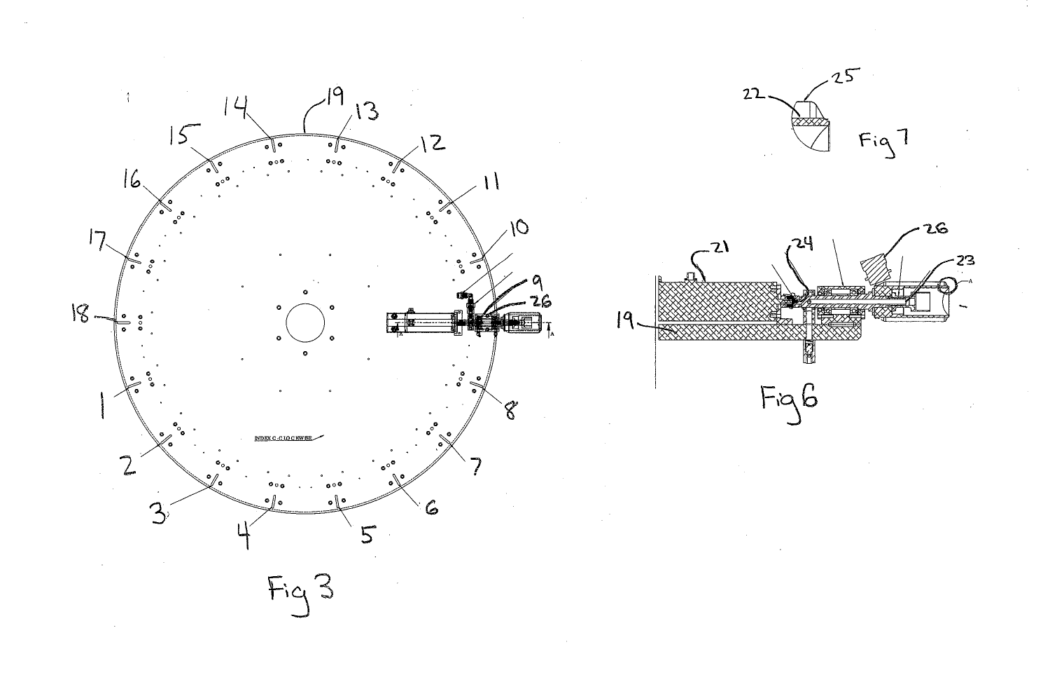

With reference to FIGS. 1-7, various views of digital printing system tables 19 of the present invention are illustrated. As illustrated here, the digital printing system comprises an eighteen station 1-18 indexing table 19 preferably comprising the following stations, each of which may be activated or deactivated during the printing process depending on the size of a cylindrical container 25 being printed or a desired design being printed on the cylindrical container 25.

### Printing Index Sequence

| Station | |
|---|---|
| No. | Operation |
| 1 | Infeed |
| 2 | Inspect/Clean |
| 3 | Contour (Neck) Printing Process Color one |
| 4 | Contour (Neck) Printing Process Color two |
| 5 | Contour (Neck) Printing Process Color three |
| 6 | Contour (Neck) Printing Process Color four - UV Cure |
| 7 | Body Printing Process Color one - 0-140 mm Length |
| 8 | Body Printing Process Color two - 0-140 mm Length |
| 9 | Body Printing Process Color three- 0-140 mm Length |
| 10 | Body Printing Process Color four -0-140 mm Length |
| 11 | Body Printing Process Color one - 140 mm-200 mm Length |
| 12 | Body Printing Process Color two - 140 mm-200 mm Length |
| 13 | Body Printing Process Color three - 140 mm-200 mm Length |
| 14 | Body Printing Process Color four - 140 mm-200 mm Length |
| 15 | Spot Color |
| 16 | Spot Color |
| 17 | Inspect/Reject |
| 18 | Discharge |

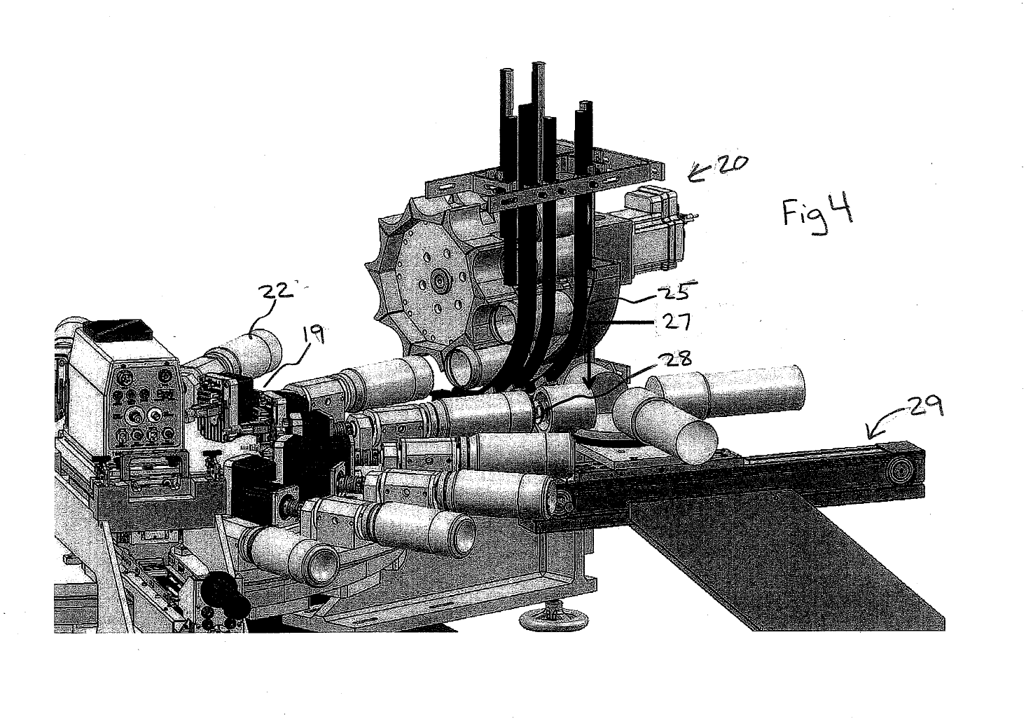

Cylindrical containers 25 are loaded from an infeed mechanism 20 comprising a servo motor driven gravity fed star-wheel with interchangeable pockets (as illustrated in FIG. 4) that can be designed to match a container shape and size and has easily adjustable guide rails to allow for product size change-over. The table 19 is driven by a servo motor 21 system to provide rigidity and accuracy to the digital printing system.

Each cylindrical container 25 is inspected in station 2 to ensure there are no defects and the cylindrical container 25 is loaded concentrically. In addition, each cylindrical container 25 is cleaned in station 2 using an atmospheric plasma cleaning process to remove any residue that would prevent the inks from adhering to the substrate.

The indexing table 19 is mounted horizontally and supports eighteen separate servo motor 21 driven mandrel assemblies 22. Each mandrel 22 is supplied with a vacuum 23 through the center of a drive shaft 24 and will hold one cylindrical container 25 and rotate the cylindrical container 25 under print heads 26 at a constant speed through multiple revolutions as needed to achieve up to 600 dpi resolution. The print heads 26 may be operated to print during four revolutions of a substrate or printing surface of the cylindrical container 25 while the index table 19 is stationary or in a “dwell period.” However, the operation of the print heads 26 and revolutions of the cylindrical container 25 may be varied by a computer operated motion control system to achieve multiple combinations of speed and positioning programmed to obtain various print effects such as holograms, tactile surface and so forth.

Each print head 26 is dedicated to one of four specific colors, Cyan, Magenta, Yellow and Black (CMYK).

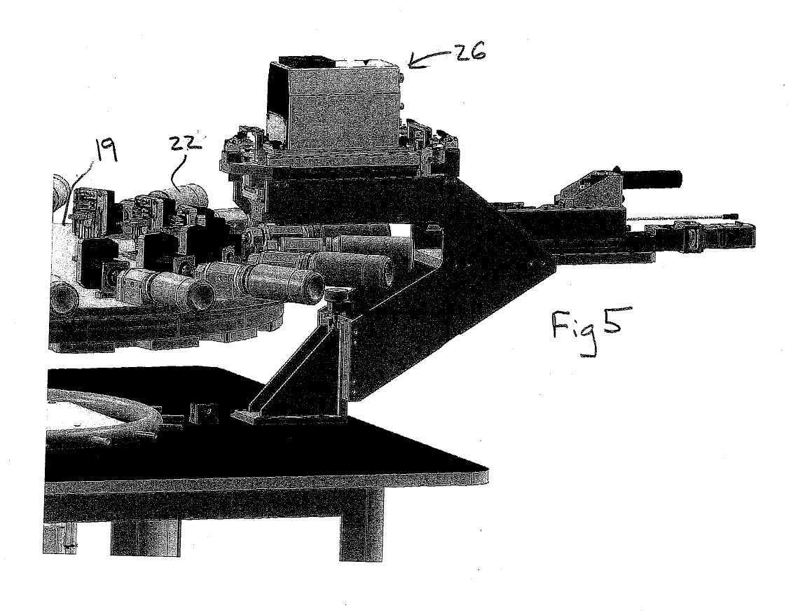

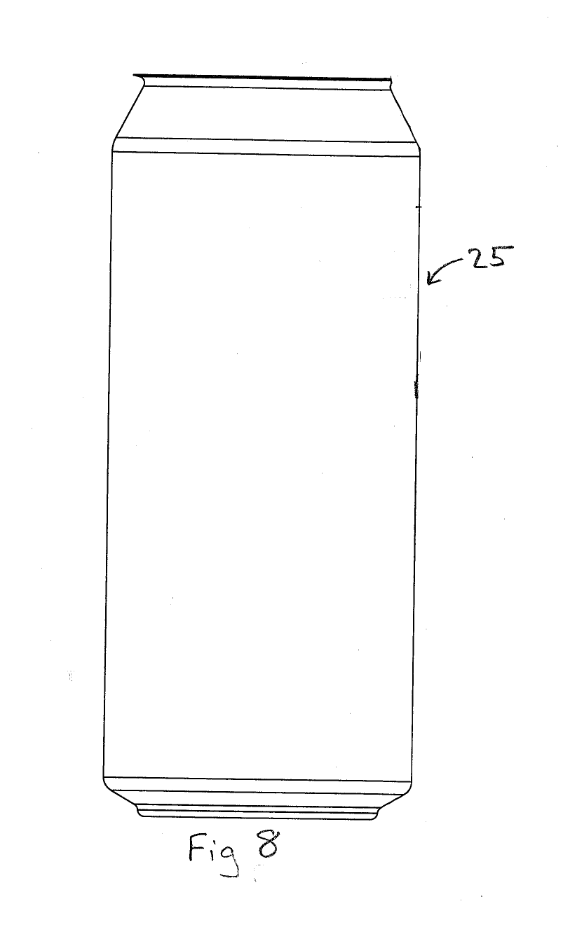

Contour printing is achieved using four angled piezoelectric print heads 26 (as illustrated in FIG. 6) and Ultra Violet (UV) cured inks in index table 19 in stations 3 thru 6 with final UV cure happening in station 6.

The straight sides of the product are printed in stations 7 thru 14 and are cured in stations 15 and 16 where an additional spot color or other process may be applied if desired.

The length of the print heads 26 used to print the straight sides or body of the cylindrical containers 25 has a maximum length of 104 mm. Therefore in order to print patterns longer than 104 mm the print heads 26 must be staggered around the table 19 in relation to the position of the cylindrical container 25 on the mandrel 22. Therefore, stations 7-10 have print heads 26 positioned to print a top part of the substrate of the cylindrical container 25 up to 104 mm in length and print heads 26 in stations 11-14 are designated to print the bottom portion of the cylindrical container 25 up to 200 mm total length or remain idle if cylindrical container 25 having a shorter height are being printed. Therefore, cylindrical containers 25 having various sizes, such as 12 oz. 20 oz., 32 oz. and so forth, may be printed using this staggered configuration

A final quality inspection is done in station 17 for each printed cylindrical container 25 thus providing 100% visual inspection prior to being discharged from the indexing table 19 (as illustrated further in FIG. 14).

Once the inspected product is indexed into station 18, the vacuum source 23 is disconnected and compressed air is supplied to the mandrel drive shaft 24 to eject the cylindrical container 25 from the mandrel 22 horizontally or vertically utilizing a vacuum pick and place system 27 (as illustrated in FIG. 4) that is easily integrated into any production line. A suction cup 28 is simultaneously positioned to receive the cylindrical container 25 and guide it off the mandrel 22. Once a transfer system 29 has received the cylindrical container 25, the table 19 indexes the empty mandrel 22 to be reloaded at the first station 1.

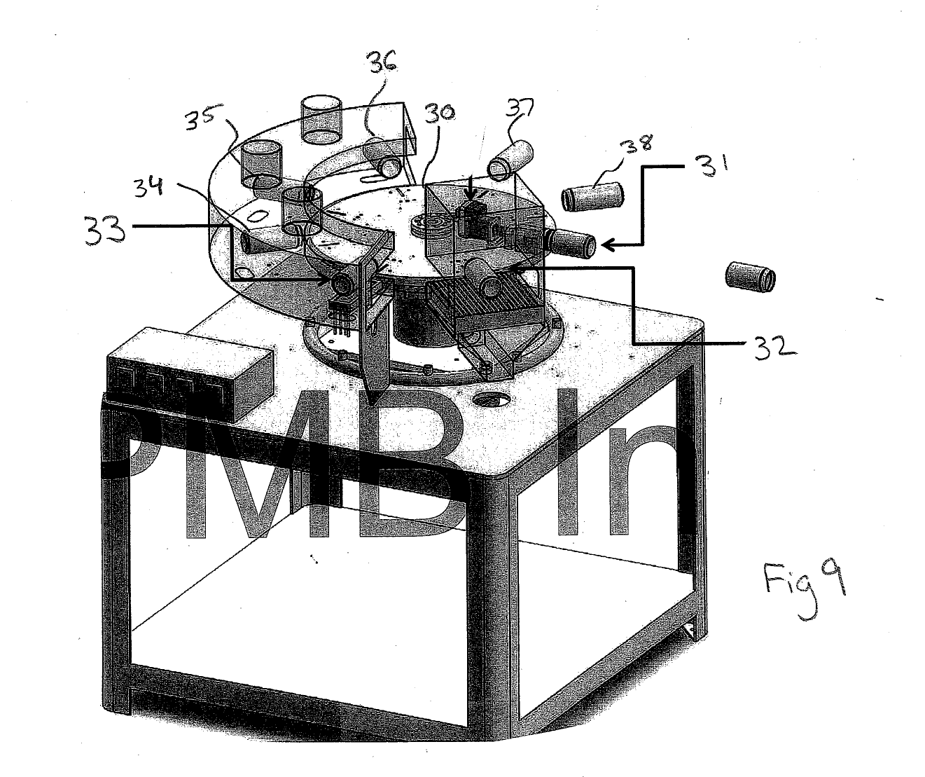

With reference to FIG. 9, a side perspective view of a clear coating system of the present invention is illustrated. After printing, the transfer system 29 places the cylindrical container 25 onto a second indexing table 30 with eight stations containing servo motor 21 driven mandrel assemblies 22 on which a clear over coating is applied and cured. First, the cylindrical container 25 is loaded at station one 31. Then, a clear coating is applied at station two 32. The clear coating is cured at stations three through seven 33-37. Finally, the cylindrical container 25 is discharged at station eight 38.

### Clear Coat Index Sequence

| Station | |
|---|---|
| No. | Operation |
| 1 | Infeed |
| 2 | Clear coat Application |
| 3 | Curing |
| 4 | Curing |
| 5 | Curing |
| 6 | Curing |
| 7 | Curing |
| 8 | Discharge |

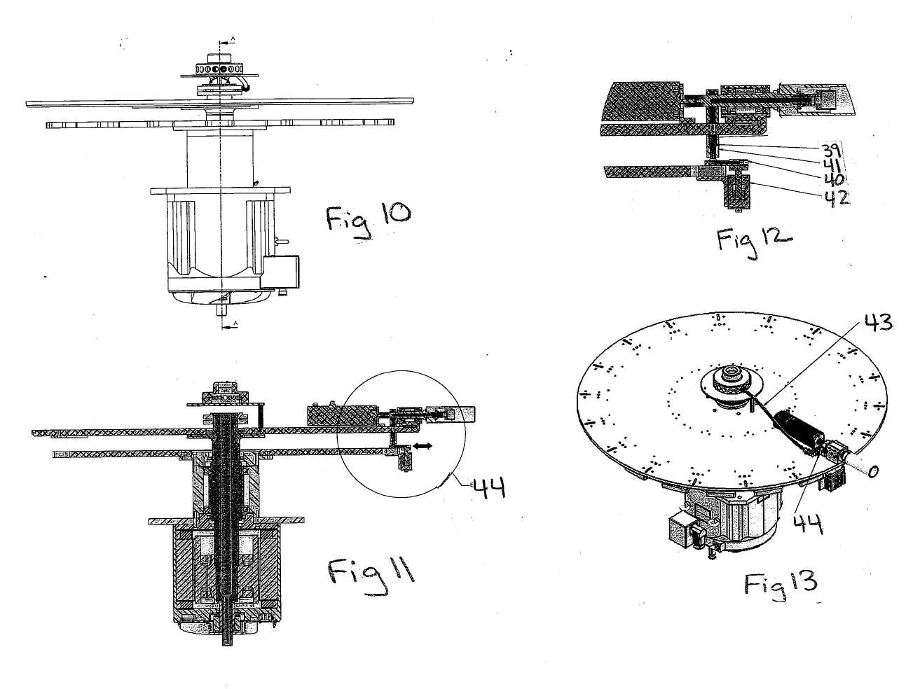

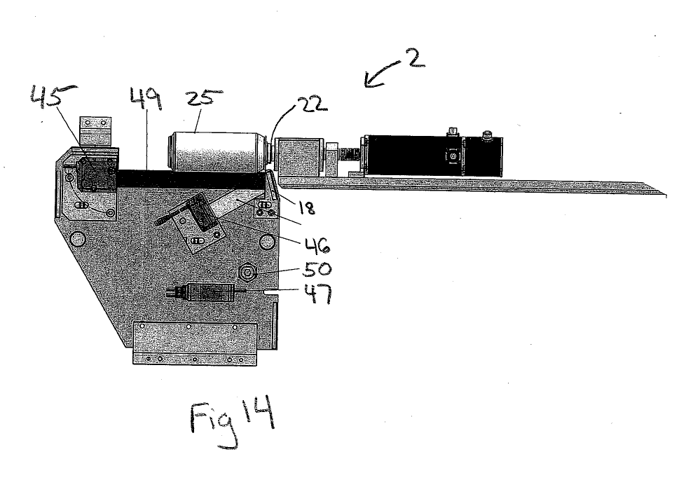

With reference to FIGS. 10-13, a vacuum system of the present invention is illustrated. Cans or cylindrical containers are loaded onto the support mandrels 22 with vacuum supplied through the mandrel drive shaft 24. There are preferably two sources of vacuum in the system, holding vacuum and high vacuum. High vacuum is connected to the mandrel drive shaft 24 when a pneumatically operated slide 39 extends a ported plate 40 with a seal which contacts the bottom of a valve 41 and lifts the valve 41 which is closely guided in a valve body 42 until a matching tapered seat inside the valve body 42 is opened and allows air to flow past sealing surfaces. This operation occurs when the rotary index table 19 is stationary during the printing sequence. There is preferably a valve assembly 41 located under each mandrel station on both indexing tables 19 and 30.

There are preferably at least three locations in the system where high vacuum is used:
1. Infeed Can Load on the Print Table 1;
2. Transfer system Rotary Indexer 29; and
3. Infeed Can Load on the Over Varnish System 31.

The holding vacuum is used on each of the plurality of mandrels 22 to maintain registration of the can on each mandrel 22 during indexing and printing/coating operations. The holding vacuum is supplied through a rotary union located above the center of the indexing table 19 mounted to a manifold which distributes the vacuum to each mandrel assembly via tubing 43 and a check valve assembly 44.

During indexing, each valve assembly 41, which is connected to the rotary table, provides a seal so the holding vacuum is isolated from a high vacuum port which is open to atmosphere.

There are preferably three locations where the system needs to alternate between vacuum for loading or holding registration and compressed air to blow the can off the mandrel 22 when printing is finished or the can is determined to be out of specification due to a damaged profile or unacceptable graphics.

The blow-off locations may be:
1. Infeed station 1;
2. Inspection station 2;
3. Graphics inspection station 17; and
4. Finished can discharge 18.

During a blow-off function, the check valve 44 prevents an compressed air pulse from disturbing other cans under vacuum and directs the compressed air through the intended mandrel shaft 24. The check valve 44 also closes when there are no cans on the mandrels 22 to prevent a vacuum leak during start-up when there are no cans in the system, or when a can has been rejected or transferred.

With reference to FIG. 14, a side view of an inspection system station 2 of the present invention is illustrated. The infeed inspection system 2 is designed to detect damaged cylindrical containers 25 and remove them from the system. The inspection station 2 is located directly adjacent to the infeed station 1 and prior to the first printing station 3 on the printing rotary table or indexing table 19.

When a cylindrical container 25 is loaded onto a mandrel 22 in the infeed station 1, it is possible for the cylindrical container 25 to have a dented side wall and still load onto the mandrel 22 due to the shape of the necked cylindrical container 25. The neck opening is smaller than the body diameter necessitating a smaller mandrel than the inside dimension of the cylindrical container 25 body be used to locate and support the container during printing/coating.

To eliminate potential damage of a print head due to the close proximity of the print head to the surface of the cylindrical container 25, an inspection system 2 has been developed as illustrated here.

The inspection system 2 consists of a laser micrometer transmitter 45, receiver 46, amplifier 47, and mirror 48 configured so a transmitted laser beam path 49 intersects the side wall of the inspection system 2 and measure any dimensional variations as the container is rotated by the mandrel assembly 22.

When the indexing table 19 moves a inspection system 2 into position, the mandrel 22 rotates the inspection system 2 at least one full circumference in the beam path 49 and is measured. If the measurements fall outside set parameters, the control system indexes the rotary table 19 to a reject position and the out of spec. inspection system 2 is blown off, and the system continues to normal operation.

The laser micrometer system has been selected due to its 28 mm wide beam path which allows for a range of container sizes to be run through the system without the need to physically adjust the beam path location. All that is necessary to change product sizes is to alter the control system computer program menu and select the appropriate container size for inspection set up.

An air purge nozzle 50 is located inside the inspection system enclosure to provide a positive, clean, dry, air flow across the optics to help keep them clean.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A digital printing system for cylindrical containers comprising:
an indexing table having a plurality of stations and at least one mandrel for supporting a cylindrical container as the cylindrical container is moved through the plurality of stations;
at least one motor for controlling movement of the indexing table;
said plurality of stations includes a first printing station wherein a first predetermined color is applied to the cylindrical container;
said plurality of stations includes a second printing station wherein a predetermined color is applied to the cylindrical container;
said plurality of stations includes a third printing station wherein a predetermined color is applied to the cylindrical container; and
said plurality of stations includes a fourth printing station wherein a predetermined color is applied to the cylindrical container.

2. The digital printing system for cylindrical containers of claim 1 wherein:
said predetermined colors being applied by the first printing station, the second printing station, the third printing station and the fourth printing station comprise cyan, magenta, yellow and black.

3. The digital printing system for cylindrical containers of claim 1 wherein:
said plurality of stations further comprises an infeed station wherein the cylindrical container is placed on the at least one mandrel.

4. The digital printing system for cylindrical containers of claim 1 wherein:
said plurality of stations further comprises an inspection station wherein cylindrical container is inspected for defects.

5. The digital printing system for cylindrical containers of claim 1 wherein:
said plurality of stations further comprises an inspection station wherein cylindrical container is inspected for defects.

6. The digital printing system for cylindrical containers of claim 1 wherein:
said predetermined colors being applied by the first printing station, the second printing station, the third printing station and the fourth printing station are being applied to a neck of the cylindrical container.

7. The digital printing system for cylindrical containers of claim 2 wherein:
said predetermined colors being applied by the first printing station, the second printing station, the third printing station and the fourth printing station are being applied to a neck of the cylindrical container.

8. The digital printing system for cylindrical containers of claim 1 wherein:
said predetermined colors being applied by the first printing station, the second printing station, the third printing station and the fourth printing station are being applied to a body of the cylindrical container.

9. The digital printing system for cylindrical containers of claim 2 wherein:
said predetermined colors being applied by the first printing station, the second printing station, the third printing station and the fourth printing station are being applied to a body of the cylindrical container.

10. The digital printing system for cylindrical containers of claim 1 wherein:
said plurality of stations further comprises discharge station.

11. The digital printing system for cylindrical containers of claim 1 further comprising:
at least one vacuum for holding the cylindrical container on the at least one mandrel.

12. The digital printing system for cylindrical containers of claim 1 further comprising:
at least one vacuum for discharging the cylindrical container off of the at least one mandrel.

13. A digital printing system for cylindrical containers comprising:
at least one mandrel for supporting a cylindrical container while colors are applied to a cylindrical container;
a first printing head for applying a predetermined color;
a second printing head for applying a predetermined color;
a third printing head for applying a predetermined color; and
a fourth printing head for applying a predetermined color.

14. The digital printing system for cylindrical containers of claim 13 wherein:
said predetermined colors being applied by the first printing head, the second printing head, the third printing head and the fourth printing head comprise cyan, magenta, yellow and black.

15. The digital printing system for cylindrical containers of claim 13 wherein:
said predetermined colors being applied by the first printing head, the second printing head, the third printing head and the fourth printing are being applied to a body of the cylindrical container.

16. The digital printing system for cylindrical containers of claim 14 wherein:
said predetermined colors being applied by the first printing head, the second printing head, the third printing head and the fourth printing are being applied to a body of the cylindrical container.

17. The digital printing system for cylindrical containers of claim 13 wherein:
said predetermined colors being applied by the first printing head, the second printing head, the third printing head and the fourth printing are being applied to a neck of the cylindrical container.

18. The digital printing system for cylindrical containers of claim 14 wherein:
said predetermined colors being applied by the first printing head, the second printing head, the third printing head and the fourth printing are being applied to a neck of the cylindrical container.
